(19) United States
(12) Patent Application Publication
(10) Pub. No.: US 2022/0235472 A1
(43) Pub. Date: Jul. 28, 2022

(54) ELECTROCHEMICAL DEHYDROGENATION OF ETHANE TO ETHYLENE USING SOLID OXIDE ELECTROLYZER

(71) Applicant: University of South Carolina, Columbia, SC (US)

(72) Inventor: Fanglin Chen, Irmo, SC (US)

(73) Assignee: University of South Carolina, Columbia, SC (US)

(21) Appl. No.: 17/533,432

(22) Filed: Nov. 23, 2021

Related U.S. Application Data
(60) Provisional application No. 63/142,615, filed on Jan. 28, 2021.

(51) Int. Cl. C25B 3/03; C25B 11/047; C25B 3/26; C25B 1/23; C25B 1/02

(52) U.S. Cl. CPC C25B 3/03; C25B 11/047; C25B 1/02; C25B 1/23; C25B 3/26

(57) ABSTRACT

Described herein is an electrochemical process to improve the yields obtained while converting ethane to ethylene with high yield, which utilizes CO₂ to make CO concurrently, while solving the low conversion, low selectivity, and catalyst coking challenges for conversion ethane to ethylene currently present in the petrochemical industry.

### STATEMENT REGARDING FEDERALLY SPONSORED RESEARCH

This disclosure was made with government support under 1832809 awarded by the National Science Foundation. The government has certain rights in the disclosure.

### TECHNICAL FIELD

The subject matter disclosed herein is generally directed to methods and electrochemical processes to improve the yields obtained while converting ethane to ethylene with high yield, which utilizes CO₂ to make CO concurrently, while solving the low conversion, low selectivity, and catalyst coking challenges for conversion ethane to ethylene currently present in the petrochemical industry.

### BACKGROUND

The conversion of ethane, a main component of natural gas, to ethylene feed stock has attracted widespread attention since the worldwide shale gas revolution. Thermal catalysis of ethane to ethylene, mainly oxidative dehydrogenation, faces the fundamental challenge of low conversion, low selectivity, and catalyst coking.

Shale gas has demonstrated a huge potential to revolutionize the energy and chemical industry because of the recent increase in proven reserves. Ethylene (C₂H₄ ) is one of the basic components for the synthesis of chemical products in the chemical industry. Because of the high fraction of ethane (C₂H₆) in shale gas (>20 vol %), C₂H₆ has become a rich and economically attractive raw material for C₂H₄ production.

Currently, the steam cracking of the tubular furnace is the main technology of C₂H₄ production, and ˜99% of global C₂H₄ production uses the tubular furnace pyrolysis. Typically, the steam cracking of C₂H₆ has a conversion rate of 70%, with C₂H₄ yields of about 50%. However, the steam cracking still faces fundamental challenges including thermal constraints, operation at high temperatures, and energy-intensive process.

An alternative to the steam cracking method is oxidative dehydrogenation (ODH) of C₂H₆ (C₂H₆+O₂=2C₂H₄+2H₂O and C₂H₆+CO₂=C₂H₄+CO+H₂O). The ODH process can reduce carbon deposition from ethane splitting by lowering operation temperature. There are reports of C₂H₄ yields of ˜42% (750° C.) and ˜63% (850° C.) with C₂H₄ selectivity up to ˜90%. However, the possible deep oxidation of hydrocarbons would reduce the C₂H₄ selectivity, and the mixture of C₂H₆ and O₂ is a potential safety hazard. In contrast, nonoxidative ethane dehydrogenation (EDH) avoids most ODH-related problems. The EDH process is more attractive to the transformation of gas containing C₂H₆, such as shale field gas, refinery off-gas, and shale gas in unfavorable geographical locations. The C₂H₆ conversion is ˜28% and the C₂H₄ selectivity is about 70% at 600° C. with ZSM-5 zeolite supported Fe catalysts. The shortcoming of EDH is that C₂H₄ and H₂ cannot be separated, which leads to low C₂H₆ conversion and C₂H₄ selectivity. Hence, if H₂ can be selectively removed from the reaction system, the conversion of C₂H₆ is no longer restricted by thermodynamic equilibrium, allowing the conversion rate of C₂H₆ to be increased at a lower temperature and developing active catalysts with high C₂H₄ selectivity and coking resistance.

Accordingly, it is an object of the present disclosure to provide an efficient conversion of ethane to ethylene in a nonoxidative dehydrogenation process in a proton-conducting solid oxide electrolyzer at ambient pressure and 700° C. Citation or identification of any document in this application is not an admission that such a document is available as prior art to the present disclosure.

### SUMMARY

The above objectives are accomplished according to the present disclosure by providing a method for forming an improved fuel cell. The method may include electrochemical pumping of protons at at least one anode, enhancing anode activity with at least one exsolved metal-oxide interface, converting ethane to ethylene at the at least one anode, reducing carbon dioxide to carbon monoxide at the at least one cathode, and producing syngas at the at least one cathode. Further, electrochemical pumping of protons may employ at least one barium zirconate cerate electrolyte. Again, the method may restrain carbon coking with respect to converting ethane to ethylene. Still yet, the method may apply an external voltage to tailor converting ethane to ethylene. Further again, the method may employ a redox-reversible ceramic electrode. Still again further, the redox-reversible ceramic electrode comprises NbTiO. Yet further, the method may include doping Mn in a lattice to create oxygen vacancy to facilitate ionic conduction. Even further, the method may form a scaffold to accommodate the exsolved metal-oxide interface for electrochemical dehydrogenations of ethane in a solid oxide electrolyzer. Further again, the method may form at least one electrode slurry comprising Ni-NTMO and barium zirconate cerate. Again further, the syngas may comprise hydrogen.

In a further embodiment, an electrochemical fuel cell system may be provided. The fuel cell system may include at least one proton conducting solid oxide electrolyzer for providing a nonoxidative dehydrogenation process, at least one anode comprising at least one alloy nanoparticle exsolved onto at least one backbone to form an embedded metal-oxide interface structure, wherein the embedded metal-oxide interface structure facilitates dehydrogenation of ethane to ethylene, at least one cathode configured for reducing CO2, and at least one electrode slurry. Further, the at least one alloy nanoparticle may include NiCu and the at least one backbone may comprise NTMO. Still further, the at least one cathode may include Ni-BCZYYb. Further again, the at least one electrode slurry may include Ni-NTMO and barium zirconate cerate. Still yet again, the embedded metal-oxide interface structure may form an anchoring interface architecture that prohibits sintering of metal particles and resists carbon deposition. Further yet, the anode may be configured to conduct nonoxidative dehydrogenation of ethane to ethylene. Even further, the cathode may be configured to produce hydrogen gas. Still yet further, the embedded metal-oxide interface structure is exsolved in situ and at formed at a nanoscale.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows C₂H₆ is converted to C₂H₄ in the anode and H+ in the anode, while CO₂ is reacting with H+ to generate CO and H₂O in the cathode in a simultaneous process in a proton-conducting solid oxide electrolyzer.

FIG. 2 shows at: (a) XRD of oxidized samples; (b) XRD of reduced samples; (c) an SEM image of the reduced Ni_{0.5}Cu_{0.5}-NTMO; and (d) HRTEM microscopic result of the reduced Ni_{0.5}Cu0.5-NTMO.

FIG. 3 shows at: (a) current-voltage (I-V) curves of the solid oxide electrolyzers with different anodes for C₂H₆ dehydrogenation at 700° C.; (b) short-term operation of C₂H₆ dehydrogenation with the composite anodes at different voltages; (c) electrode polarizations with different anodes at 0.4-0.8 V at 700° C.; (d) a potential energy profile for the ethane dehydrogenation on NiCu/TiO₂ interface.

FIG. 4 shows at: (a) product analysis of electrochemical dehydrogenation of C₂H₆ with different anodes; (b) C₂H₆ conversion and C₂H₄ selectivity; (c) The amount of H₂ depends on the current in the cathode; and (d) short-term performance of the electrochemical dehydrogenation of C₂H₆ with the Ni_{0.25}Cu_{0.75}-NTMO anode in a proton-conducting SOE (α: Cu-NTMO, β: Ni_{0.25}Cu_{0.75}-NTMO, Y: Ni_{0.5}Cu_{0.5}-NTMO, δ: Ni_{0.75}Cu_{0.25}-NTMO, ε: Ni-NTMO).

FIG. 5 shows at: (a) current-voltage (I-V) relationship of CO₂ electrolysis with C₂H₆ conversion at 700° C.; (b) cathode product analysis at various voltages; (c) product analysis in the anode; (d) SEM images of the Ni_{0.5}Cu_{0.5}-NTMO porous electrodes after electrochemical test (α: Cu-NTMO, β: Ni_{0.25}Cu_{0.75}-NTMO, Y: Ni_{0.5}Cu_{0.5}-NTMO, δ: Ni_{0.75}Cu_{0.25}-NTMO, ε: Ni-NTMO).

FIG. 6 shows XRD rietveld refinement patterns of: (a) oxidized NTMCuO; (b) reduced Cu-NTMO; (c) oxidized NTMNi_{0.5}Cu_{0.75} O; (d) reduced Ni_{0.25}Cu_{0.75}-NTMO; (e) oxidized NTMNi_{0.5}Cu_{0.50}; (f) reduced Ni_{0.5}Cu_{0.5}-NTMO.

FIG. 7 shows XRD rietveld refinement patterns of: (a) oxidized NTMNi_{0.75}Cu_{0.25}O; (b) reduced Ni_{0.75}Cu_{0.25}-NTMO; (c) oxidized NTMNiO; (d) reduced Ni-NTMO.

FIG. 8 shows X-ray photoelectron spectroscopy of: (a) Mn, (c) Ni, (e) Cu in the oxidized NTMNi_{0.5}Cu_{0.5}O; (b) Mn, (d)Ni, (f) Cu in the reduced Ni_{0.5}Cu_{0.5}-NTMO.

FIG. 9 shows TGA tests of the reduced samples from 100 to 1100° C. in air.

FIG. 10 shows the dependence of mixed conductivity on temperature of the reduced samples in (a) 5% H₂/Ar and (b) air atmosphere.

FIG. 11 shows an oxygen exchange coefficient diagram of the reduced samples.

FIG. 12 shows the cross-sectional microstructure of a solid oxide electrolyzer with a configuration of N_{0.5}Cu_{0.5}-NTMO-SDC|BCZYYb|Ni-BCZYYb before test.

FIG. 13 shows AC impedance of solid oxide electrolyzers based on: (a) Cu-NTMO, (b) Ni_{0.25}Cu_{0.75}-NTMO, (c) Ni_{0.5}Cu_{0.5}-NTMO, (d) Ni_{0.75}Cu_{0.25}-NTMO, and (e) Ni-NTMO anodes under various potentials at 700° C.

FIG. 14 shows optimization structure and binding energy of clusters for: (a) Ni11 cluster; (b) Cu11 cluster; (c) (Ni—Cu)−1 cluster; (d) (Ni—Cu)−2 cluster; (e) (Ni—Cu)−3 cluster ; and (f) (Ni—Cu)−4 cluster.

FIG. 15 shows different adsorption configurations of ethane on the TiO2 system at: (a) the defect surface; (b) the Ni/TiO₂ system; (c) The Cu/TiO₂ system; (d) The Ni—Cu/TiO₂ system.

FIG. 16 shows a potential energy profile for the ethane dehydrogenation on (a) TiO₂ defect surface, (b) Cu/TiO₂ interface, (c) Ni/TiO₂ interface and (d) NiCu/TiO₂ interface.

FIG. 17 shows product analysis from thermal splitting C₂H₆ in the anode of solid oxide electrolyzer without externally applied voltages at operation temperature of 700° C.

FIG. 18 shows at: (a) Faradaic efficiency for 112 in cathode for electrochemical dehydrogenation of C₂H₆; (b) Faradaic efficiency for CO/H₂ in cathode for electrochemical dehydrogenation of C₂H₆ in conjunction with CO₂ reduction in cathode; (c) Faradaic efficiency for C₂H₄ production in anode for electrochemical dehydrogenation of C₂H₆; (d) Faradaic efficiency for C₂H₄ production in anode for electrochemical dehydrogenation of C₂H₆ with CO₂ reduction. (α: Cu-NTMO, β: Ni_{0.25}Cu_{0.75}-NTMO, Y: Ni_{0.5}Cu_{0.5}-NTMO, δ:Ni_{0.75}Cu_{0.25}-NTMO, ε: Ni-NTMO).

FIG. 19 shows C₂H₆ conversion at different modes with Ni_{0.5}Cu_{0.5}-NTMO anode in solid oxide electrolyzer.

FIG. 20 shows at: (a) EDX mapping in HAADF-STEM mode of Ni_{0.5}Cu_{0.5}-NTMO anode after stability test for electrochemical dehydrogenation of C₂H₆; (b) EDX elemental line analysis across typical Ni_{0.5}Cu_{0.5} particle; (c, d) Cu and Ni mapping of the exsolved nanop article.

FIG. 21 shows X-ray photoelectron spectroscopy of (a) Mn, (b) Ni, (c) Cu in Ni_{0.5}Cu_{0.5}-NTMO anode before and after stability test for electrochemical dehydrogenation of C₂H₆; (d) SEM images of the Ni_{0.5}Cu_{0.5}-NTMO porous electrodes after stability test for C₂H₆ conversion.

FIG. 22 shows optimized structure of ethane deep cracking process at: (a-c) C₂H₆ (g) on cluster/TiO₂ system; (d-f) C adsorbed on cluster/TiO₂ system; (g-i) H₂ (g) on cluster/TiO₂ system. (a), (d) and (g): on (Ni—Cu)/TiO₂ system; (b), (e) and (h): on Ni/TiO₂ system; (c), (f) and (i): on Cu/TiO₂ system.

FIG. 23 shows at: (a) short-term operation of C₂H₆ dehydrogenation with the composite anodes in combination with CO₂ reduction at different voltages; and (b) electrode polarizations with different anodes at 0.4-0.8 V at 700° C.

FIG. 24 shows AC impedance of solid oxide electrolyzers based on (a) Cu-NTMO, (b) Ni_{0.25} CU_{0.75}-NTMO, (c) Ni_{0.5} CU_{0.5}-NTMO, (d) Ni_{0.75}CU_{0.25}-NTMO, (e) Ni-NTMO anodes under various potentials at 700° C.

FIG. 25 shows at: (a) directly pumping the gas mixture of H₂/CO₂ to cathode under open circuit conditions, where the H₂ is identical to the H₂ generation amount in cathode during electrochemical C₂H₆ dehydrogenation; and (b) the ratio of CO/H₂ at different modes in the cathode.

FIG. 26 shows at: (a) C₂H₆ conversion and C₂H₄ selectivity in anode in combination with CO₂ reduction in cathode; (b) The short term performance of the electrochemical dehydrogenation of C₂H₆ with the Ni0.5 Cu0.5-NTMO anode in a proton-conducting solid oxide electrolyzer. (α: Cu-NTMO, β: Ni_{0.25}Cu_{0.75}-NTMO, Y: Ni_{0.5}Cu_{0.5}-NTMO, δ:Ni_{0.75}Cu_{0.25}-NTMO, ε: Ni-NTMO).

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g. given data set, art accepted standard, and/or with e.g. a given confidence interval (e.g. 90%, 95%, or more confidence interval from the mean), such as variations of +/−10% or less, +/−5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

As used interchangeably herein, the terms “sufficient” and “effective,” can refer to an amount (e.g. mass, volume, dosage, concentration, and/or time period) needed to achieve one or more desired and/or stated result(s). For example, a therapeutically effective amount refers to an amount needed to achieve one or more therapeutic effects.

As used herein, the terms “weight percent,” “wt%,” and “wt.%,” which can be used interchangeably, indicate the percent by weight of a given component based on the total weight of a composition of which it is a component, unless otherwise specified. That is, unless otherwise specified, all wt% values are based on the total weight of the composition. It should be understood that the sum of wt% values for all components in a disclosed composition or formulation are equal to 100. Alternatively, if the wt% value is based on the total weight of a subset of components in a composition, it should be understood that the sum of wt% values the specified components in the disclosed composition or formulation are equal to 100.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

The current disclosure shows the highest ethane conversion of 75.2% and ˜100% ethylene selectivity even only at 0.8 V in this electrochemical catalysis process. The electrochemical pumping of protons at anode with active exsolved metaloxide interfaces enhances anode activity, while the metaloxide interface interactions further engineer the ethane conversion in the electrochemical dehydrogenation process. The current disclosure exsolves metaloxide interface architecture at nanoscale on the electrode scaffold to improve coking resistance and catalyst stability. The current disclosure also provides the reduction of carbon dioxide to carbon monoxide in the cathode combined with ethane conversion in the anode, and shows higher performance of ethane conversion in the anode with syngas production in the cathode. The electrochemical dehydrogenation process would provide an alternative method for the petrochemical production and a thermochemical practice in a clean energy mode.

Nonoxidative conversion of C₂H₆ to C₂H₄ is essentially a dehydrogenation process, see Wang, L.; Zhang, Y.; Xu, J.; Diao, W.; Karakalos, S.; Liu, B.; Song, X.; Wu, W.; He, T.; Ding, D. Non-oxidative Dehydrogenation of Ethane to Ethylene over ZSM-5 Zeolite Supported Iron Catalysts. Appl. Catal., B 2019, 256, 117816, which could be achieved in an electrochemical process. Proton-conducting solid oxide electrolyzers (SOEs) have been under the spotlight for their efficiency in converting electricity from renewable energy into fuels and chemicals.

They usually use ceramic components which therefore can deliver the advantages of durability and low production cost and the stack scale can be up to 100 kW. Available exhaust heat stream in industry could add additional energy to the system with an operation temperature at ˜600-900° C. This temperature region fit the operation conditions of the nonoxidative dehydrogenation process of C₂H₆ to C₂H₄. A recent study shows that the C₂H₆ conversion reaches a maximum of ˜18% with a traditional nickel-cermet anode, and the coking formation is observed in the electrochemical dehydrogenation process.

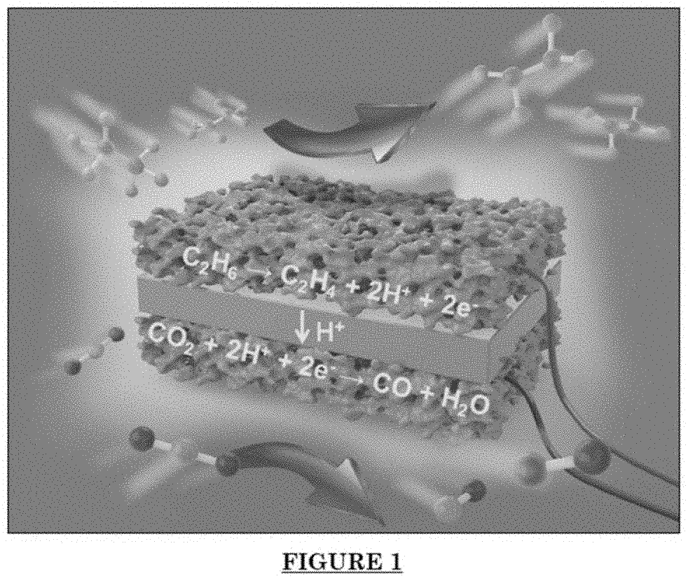

As shown in FIG. 1, C₂H₆ can be directly electrolyzed into C₂H₄ and H+ (C₂H₆→C₂H₄+2H++2e−) at the anode, while the generated H+ are transported through the electrolyte to the cathode and form H₂ (2H++2e−→H₂), under an externally applied potential in proton-conducting SOEs. When CO₂ is fed into the cathode reacting with H+ to produce CO (CO₂+2H++2e−→CO+H₂O), this would not only achieve the CO₂ reduction but also greatly improve the C₂H₆ dehydrogenation efficiency by decreasing the overpotentials between the two electrodes. This electrochemical nonoxidative dehydrogenation process of C₂H₆ into C₂H₄ would show huge application potential, and the utilization of available waste industry heat flow would further improve electricity efficiency.

As the C—H bonds of C₂H₆ are more stable than the C—C bonds, electrochemical nonoxidative dehydrogenation of C₂H₆ to C₂H₄ in a proton-conducting SOE can selectively activate and break the C—H bonds of C2H6 in the porous electrode. See, Bian, Y.; Kim, M.; Li, T.; Asthagiri, A.; Weaver, J. F. Facile Dehydrogenation of Ethane on the IrO₂ (110) Surface. J. Am. Chem. Soc. 2018, 140, 2665-2672 and Huang, R.; Zhang, B.; Wang, J.; Wu, K.; Shi, W.; Zhang, Y.; Liu, Y.; Zheng, A.; Schloegl, R.; Su, D. Direct Insight into Ethane Oxidative Dehydrogenation over Boron Nitrides. ChemCatChem 2017, 9, 3293-3297.

The electrochemical pumping of protons from C₂H₆ in the anode is indeed a process of nonoxidative dehydrogenation under the electrochemical potentials. The current disclosure uses the proton-conducting barium zirconate cerate (Ba—Ce_{0.7}Zr_{0.1}Y_{0.1}Yb_{0.1}O_{3-δ}, BCZYYb) electrolyte, which exhibits proton conductivity as high as 6.2×10⁻³ S cm-1 with very small activation energy. Yang, L.; Wang, S.; Blinn, K.; Liu, M.; Liu, Z.; Cheng, Z.; Liu, M. Enhanced Sulfur and Coking Tolerance of a Mixed Ion Conductor for SOFCs: BaZr_{0.1}Ce_{0.7}Y_{0.2-x}YbₓO_{3-δ}. Science 2009, 326, 126-129 and Chen, Y.; Bu, Y.; Zhang, Y.; Yan, R.; Ding, D.; Zhao, B.; Yoo, S. Y.; Dang, D.; Hu, R.; Yang, C.; Liu, M. A Highly Efficient and Robust Nanofiber Cathode for Solid Oxide Fuel Cells. Adv. Energy Mater. 2017, 7, 1601890. The high proton conductivity at low operation temperature and high flux would restrain the carbon coking from thermodynamic C₂H₆ splitting. Active metaloxide interfaces can selectively activate C—H bonds while the electrochemical pumping of protons would constantly dehydrogenize C₂H₆ to form C₂H₄. See, Sattler, J.; Ruiz-Martinez, J.; Santillan-Jimenez, E.; Weckhuysen, M. Catalytic Dehydrogenation of Light Alkanes on Metals and Metal Oxides. Chem. Rev. 2014, 114, 10613-10653, Xiong, H.; Lin, S.; Goetze, J.; Pletcher, P.; Guo, H.; Kovarik, L.; Artyushkova, K.; Weckhuysen, B. M.; Datye, A. K. Thermally Stable and Regenerable Pt-Sn Clusters for Propane Dehydrogenation Prepared via Atom Trapping on Ceria. Angew. Chem., Int. Ed. 2017, 56, 8986-8991, Jiao, F.; Pan, X.; Gong, K.; Chen, Y.; Li, G.; Bao, X. Shape-Selective Zeolites Promote Ethylene Formation from Syngas via a Ketene Intermediate. Angew. Chem., Int. Ed. 2018, 57, 4692-4696. Schreiber, M. W.; Plaisance, C. P.; Baumgartl, M.; Reuter, K.; Jentys, A.; Bermejo-Devg, R.; Lercher, J. A. Lewis-Bronsted Acid Pairs in Ga/H-ZSM-5 to Catalyze Dehydrogenation of Light Alkanes. J. Am. Chem. Soc. 2018, 140, 4849-4859. Schwach, P.; Pan, X.; Bao, X. Direct Conversion of Methane to Value-Added Chemicals over Heterogeneous Catalysts: Challenges and Prospects. Chem. Rev. 2017, 117, 8497-8520, Zhang, Z.; Wang, S.; Song, R.; Cao, T.; Luo, L.; Chen, X.; Gao, Y.; Lu, J.; Li, W.; Huang, W. The Most Active Cu Facet for Low-Temperature Water Gas Shift Reaction. Nat. Commun. 2017, 8, 488, and Chen, Y.; de Glee, B.; Tang, Y.; Wang, Z.; Zhao, B.; Wei, Y.; Zhang, L.; Yoo, S.; Pei, K.; Kim, J. H.; Ding, Y.; Hu, P.; Tao, F.; Liu, M. A Robust Fuel Cell Operated on Nearly Dry Methane at 500 Degrees C Enabled by Synergistic Thermal Catalysis and Electrocatalysis. Nat. Energy 2018, 3, 1042-1050. Active metal-oxide interfaces would therefore improve the coking resistance, while the synergistic control of external applied voltage would further tailor the C₂H₆ cracking process leading to excellent catalysis durability. Electronic conductor Nb_{1.33}Ti_{0.67}O_{4-δ} is a typical redox-reversible ceramic electrode material, see Li, S.; Qin, Q.; Xie, K.; Wang, Y.; Wu, Y. High-Performance Fuel Electrodes Based on NbTi_{0.5}M_{0.5}O₄ (M=Ni, Cu) with Reversible Exsolution of the Nano-Catalyst for Steam Electrolysis. J. Mater. Chem. A 2013, 1, 8984-8993, and the doping of Mn in the lattice would create the oxygen vacancy to facilitate ionic conduction, which therefore offers a suitable scaffold to accommodate the metaloxide interface for the electrochemical dehydrogenation of C₂H₆ in the solid oxide electrolyzer anode.

The typical metal catalysts including low-cost nickel and noble metal nanoparticles are generally used to construct strongly interacting metaloxide interfaces to facilitate the catalysis conversion of C₂H₆. See Sattler, J.; Ruiz-Martinez, J.; Santillan-Jimenez, E.; Weckhuysen, M. Catalytic Dehydrogenation of Light Alkanes on Metals and Metal Oxides. Chem. Rev. 2014, 114, 10613-10653. (23) Huang, W.; Sun, G.; Cao, T. Surface Chemistry of Group IB Metals and Related Oxides. Chem. Soc. Rev. 2017, 46, 1977-2000, Polo-Garzon, F.; Bao, Z.; Zhang, X.; Huang, W.; Wu, Z. Surface Reconstructions of Metal Oxides and the Consequences on Catalytic Chemistry. ACS Catal. 2019, 9, 5692-5707, Hua, Q.; Cao, T.; Gu, X.; Lu, J.; Jiang, Z.; Pan, X.; Luo, L.; Li, W.; Huang, W. Crystal-Plane-Controlled Selectivity of Cu₂O Catalysts in Propylene Oxidation with Molecular Oxygen. Angew. Chem., Int. Ed. 2014, 53, 4856-4861. By using an impregnation method, traditional metaloxide interfaces can be constructed on porous oxide scaffolds. However, the long-term instability of metal nanoparticles degrades catalysis performance, which is attributed to the nanoparticle sintering and agglomerations at high temperatures. See, Zhou, Y.; Zhou, Z.; Song, Y.; Zhang, X.; Guan, F.; Lv, H.; Liu, Q.; Miao, S.; Wang, G.; Bao, X. Enhancing CO₂ Electrolysis Performance with Vanadium-doped Perovskite Cathode in Solid Oxide Electrolysis Cell. Nano Energy 2018, 50, 43-51 and Schmies, H.; Bergmann, A.; Drnec, J.; Wang, G.; Teschner, D.; Kuhl, S.; Sandbeck, D. J. S.; Cherevko, S.; Gocyla, M.; Shviro, M.; Heggen, M.; Ramani, V.; Dunin-Borkowski, R. E.; Mayrhofer, K. J. J.; Strasser, P. Unravelling Degradation Pathways of Oxide-Supported Pt Fuel Cell Nanocatalysts under In Situ Operating Conditions. Adv. Energy Mater. 2018, 8, 1701663.

In contrast, in situ growth of exsolved metal-oxide interfaces through a reversible phase decomposition under reducing conditions would be an alternative approach to enhance catalyst stability and activity. See, Ye, L.; Zhang, M.; Huang, P.; Guo, G.; Hong, M.; Li, C.; Irvine, J. T. S.; Xie, K. Enhancing CO₂ Electrolysis through Synergistic Control of Non-stoichiometry and Doping to Tune Cathode Surface Structures. Nat. Commun. 2017, 8, 14785, Wang, W.; Gan, L.; Lemmon, J. P.; Chen, F.; Irvine, J. T. S.; Xie, K. Enhanced Carbon Dioxide Electrolysis at Redox Manipulated Interfaces. Nat. Commun. 2019, 10, 1550, and (30) Irvine, J. T. S.; Neagu, D.; Verbraeken, M. C.; Chatzichristodoulou, C.; Graves, C.; Mogensen, M. B. Evolution of the Electrochemical Interface in High-Temperature Fuel Cells and Electrolysers. Nat. Energy 2016, 1, 15014.

The anchoring of metal nanop articles on oxide particularly enhances stability and coking resistance due to the strong interactions in the exsolved metaloxide interface structures at the nanoscale. Forming alloy particles at the exsolved interface would be another way to increase coking resistance. The close interaction between different elements at atomic scale gives rise to the alloying effect which would be favorable to the catalysis activity and coking resistance for the C₂H₆ conversion to C₂H₄. See, Lu, J.; Zhu, C.; Pan, C.; Lin, W.; Lemmon, J. P.; Chen, F.; Li, C.; Xie, K. Highly Efficient Electrochemical Reforming of CH₄/CO₂ in a Solid Oxide Electrolyser. Sci. Adv. 2018, 4, eaar5100. The NiₓCu₁₋ₓ alloys would generate strong interfacial interactions in the interfacial architectures that are highly favorable for the C₂H₆ conversion to C₂H₄ in the porous electrode.

Here, the current disclosure provides the electrochemical conversion of C₂H₆ to C₂H₄ in a nonoxidative dehydrogenation process in a proton conducting SOE with the anode of NiₓCu₁₋ₓ-doped Nb_{1.33}(Ti_{0.8}Mn_{0.2})_{0.6}O_{4-δ} (NTMO). NiₓCu₁₋ₓ alloys nanoparticles are exsolved on the NTMO backbone to grow an embedded metal-oxide interface architecture. The strong interfacial interaction at exsolved metal-oxide interface would improve the stability and coking resistance at high temperature.

The current disclosure studies the electrochemical pumping of protons from C₂H₆ for the directly nonoxidative dehydrogenation in the anode. We also investigate the electrochemical dehydrogenation of C₂H₆ in conjunction with CO₂ reduction in the cathode and present the further enhanced C₂H₆ conversion.

Experimental Section

Experimental Procedures.

The current disclosure synthesized five samples of the Cu-NTMO, Ni_{0.25}Cu_{0.75}-NTMO, Ni_{0.5}Cu_{0.5}-NTMO, Ni_{0.75}Cu_{0.25}-NTMO, and Ni-NTMO using a microwaveassisted combustion method. See, Li, S.; Qin, Q.; Xie, K.; Wang, Y.; Wu, Y. High-Performance Fuel Electrodes Based on NbTi_{0.5}M_{0.5}O₄ (M=Ni, Cu) with Reversible Exsolution of the Nano-Catalyst for Steam Electrolysis. J. Mater. Chem. A 2013, 1, 8984-8993. We denote the NbTi_{0.4} Mn_{0.1}(NiₓCu₁₋ₓ)_{0.5}O_{4-δ} as NiₓCu₁₋ₓ-NTMO with x=0-1. We synthesized the BaCeo_{0.7}Zr_{0.1}Y_{0.1}Yb_{0.1}O_{3-δ} (BCZYYb) powders using a liquid-phase combustion method. See, Yang, L.; Wang, S.; Blinn, K.; Liu, M.; Liu, Z.; Cheng, Z.; Liu, M. Enhanced Sulfur and Coking Tolerance of a Mixed Ion Conductor for SOFCs: BaZr_{0.1}Ce_{0.7}Y_{0.2-x}YbₓO_{3-δ}. Science 2009, 326, 126-129. We used X-ray diffraction (XRD; Miniflex 600, Japan) and X-ray photoelectron spectroscopy (XPS; ESCALAB 250Xi, U.S.A.) to investigate the oxidized and reduced samples. The cathode supported half-cells of NiO-BCZYYb|BCZYYb are fabricated by the copressing method, following by a sintering at 1450° C. for 4 h. See Id. We prepared the electrode slurry composed of NbTi_{0.4} Mn_{0.1}(NiₓCu₁₋ₓ)_{0.5}O_{4-δ} and BCZYYb powders at a weight ratio of 65:35 with ethyl cellulose additive to form porosity. Single cells (active area is 1 cm²) were assembled with different anodes. We conducted the electrochemical tests of C₂H₆ dehydrogenation in the anode with 5% H2/Ar (or CO₂) in the cathode at 700° C. We used an electrochemical workstation (Zahner IM6, Germany) to conduct the electrochemical measurements. We used a gas chromatograph (GC; Shimazu 2014, Japan) to analyze the product gas compositions. We observed the cathode microstructures using scanning electron microscopy (SEM; SU-8010, Japan) and high-resolution transmission electron microscopy (HRTEM; Tecnai F20, U.S.A.).

Theoretical Calculations.

We conducted all the calculations of Density Functional Theory in the Vienna Ab Initio Simulation Package. Kresse, G.; Furthmuller, J. Efficiency of Ab-Initio Total Energy

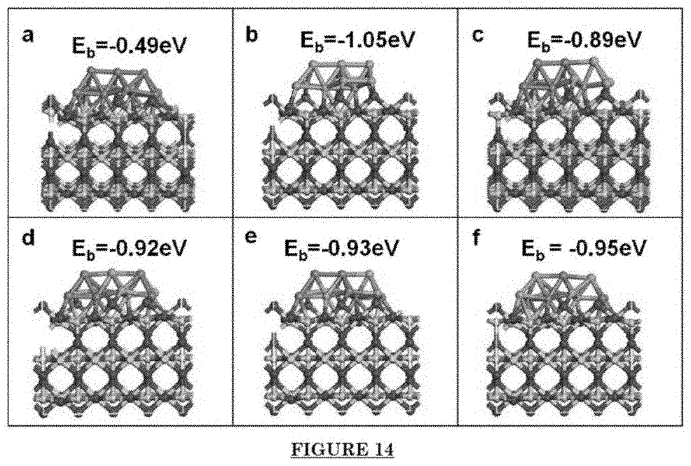

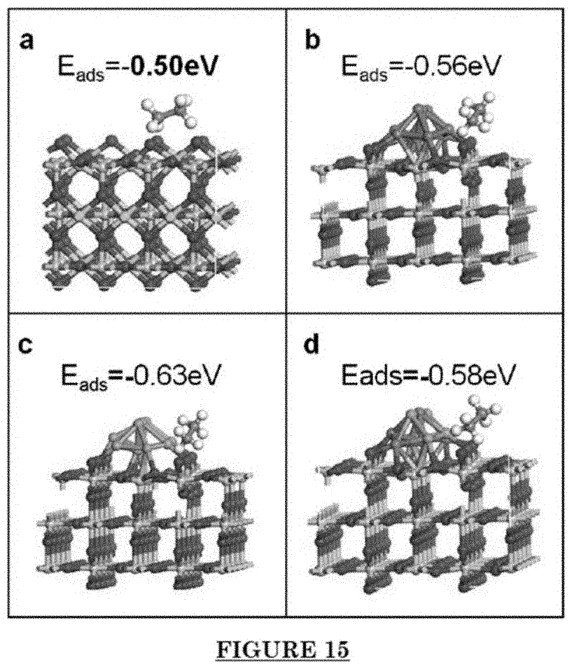

Calculations for Metals and Semiconductors Using a Plane-Wave Basis Set. Comput. Mater. Sci. 1996, 6, 15-50. We use the generalized gradient approximation, and we chose the Perdew-Burke-Ernzerhof (PBE) functional here to present the exchange correlation interactions. See, Perdew, J. P.; Burke, K.; Ernzerhof, M. Generalized Gradient Approximation Made Simple. Phys. Rev. Lett. 1996, 77, 3865-3868 We used the method of projector augmented wave (PAW) to investigate the interaction between core and valence electrons. The DFT-D3 method was implemented in VASP for the dispersion correction. The optimized rutile TiO₂ crystal with a 5×5×8 k-point grid gave a lattice parameter of 4.646 Å for a and b and 2.966 Å for c. We set an energy of 450 eV to the plane wave cutoff. We chose the periodic slab model by setting a p(4×2) superstructure with four Ti—O—Ti trilayers (48 Ti, 96 O) at (110) facet. We fixed the bottom two Ti—O—Ti trilayers, while we relaxed the top two trilayers. We set a thickness of 20 Å for the vacuum region. We sampled the Brillouin zone by using a 3×3×1 k-point grid. We calculated the energy of oxygen vacancy formation of TiO₂ (110) surface according to E_{for}=E_{def}−E_{perfect}−μ_{O}. See, Cheng, F.; Lin, G.; Hu, X.; Xi, S.; Xie, K. Porous Single-Crystalline Titanium Dioxide at 2 cm Scale Delivering Enhanced Photoelectrochemical Performance. Nat. Commun. 2019, 10, 3618. The E_{def}, E_{perfect}, and μ_{O} are the energy for a defective with a vacancy, the total energy of perfect surface and the energy of O atom taken from molecular O₂, respectively. We calculated the adsorption energy of C₂H₆ using E_{ads}=Eₜₒₜₐₗ−Eₑₜₕ−E_{slab}. Eₜₒₜₐₗ, E_{slab}, and Eₑₜₕ are the energy of the adsorption system in total, the TiO₂ (110) system without adsorption, and the ethane molecule, respectively. The structures of six clusters (Ni11, Cu11, (Ni—Cu)−1, (Ni—Cu)−2, (Ni—Cu)−3, (Ni—Cu)−4) on TiO₂ (110) surface were constructed. We simulated the metaloxide interface by setting a system composed of the Ni—Cu cluster on TiO₂ (110) with oxygen vacancy. We presented the optimized configurations of the six clusters in FIG. 14, which shows optimization structure and binding energy of clusters at: (a) Ni11 cluster; (b) Cu11 cluster; (c) (Ni—Cu)−1 cluster; (d) (Ni—Cu)−2 cluster; (e) (Ni—Cu)−3 cluster ; (f) (Ni—Cu)−4 cluster. We used the equation of E_{b}=(Eₜₒₜ−mE_{Cu}−nE_{Ni}−E_{slab})/(m+n) to study the binding energy (Eₕ) of the Ni/Cu atoms at surfaces. Eₜₒₜ, E_{slab}, E_{Cu}, and E_{Ni} are the energy of Ni/ Cu atoms at the surface in total, the surface, a Cu atom, and a Ni atom, respectively. The m and n indicate the number of Cu and Ni atoms, respectively. We chose the (Ni—Cu)−4 structures for the subsequent calculation. The adsorption energy of C₂H₆ at interface was calculated according to the equation of E_{ads}=Eₜₒₜₐₗ−EₑₜₕE_{slab}−Eₜₒₜₐₗ, E_{slab}, and Eₑₜₕ are the energy of the adsorption system in total, the TiO₂ (110) system with cluster adsorption, and the ethane molecule, respectively. The structure after optimization and adsorption energy are shown in FIG. 15, which shows different adsorption configurations of ethane on the TiO2 system at: (a) the defect surface; (b) the Ni/TiO2 system; (c) the Cu/TiO2 system; (d) the Ni—Cu/TiO2 system. We conducted the transition state (TS) searches by the climbing image nudged elastic band (CI-NEB) method. See, Henkelman, G.; Uberuaga, B. P.; Jonsson, H. A Climbing Image Nudged Elastic Band Method for Finding Saddle Points and Minimum Energy Paths. J. Chem. Phys. 2000, 113, 9901-9904.

Results and Discussion

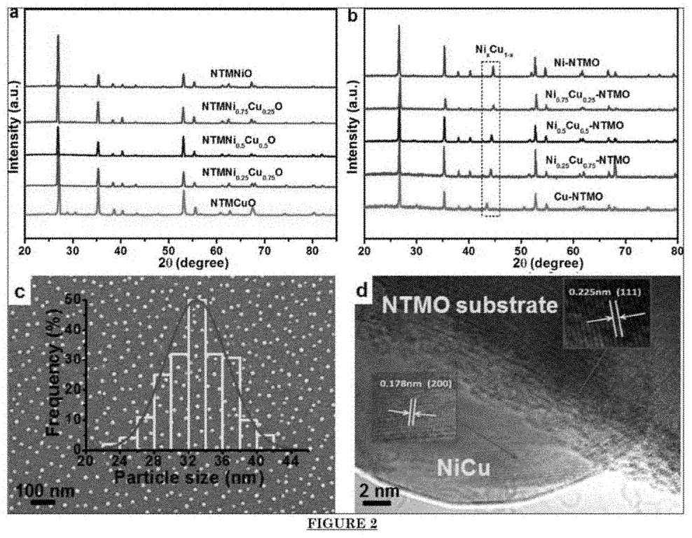

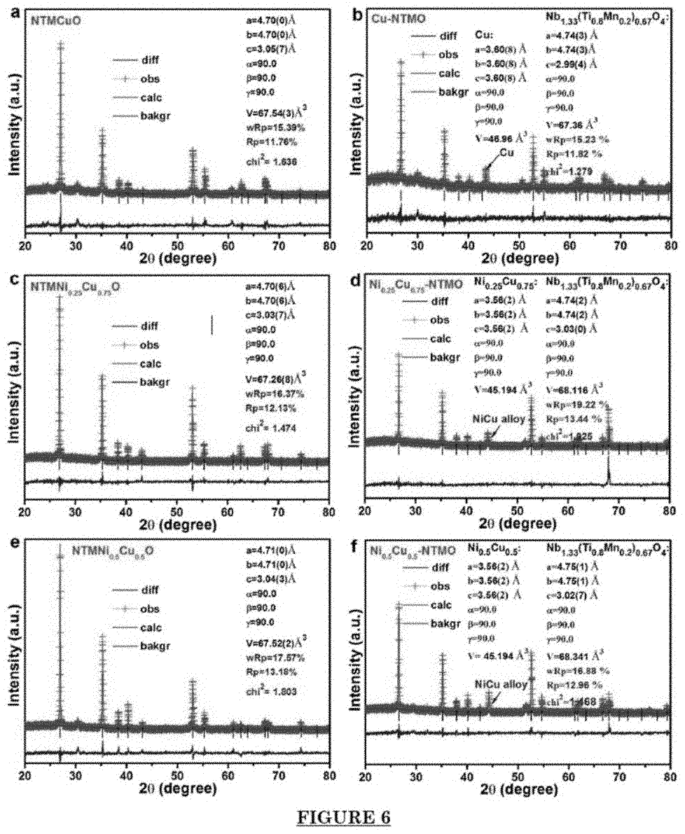

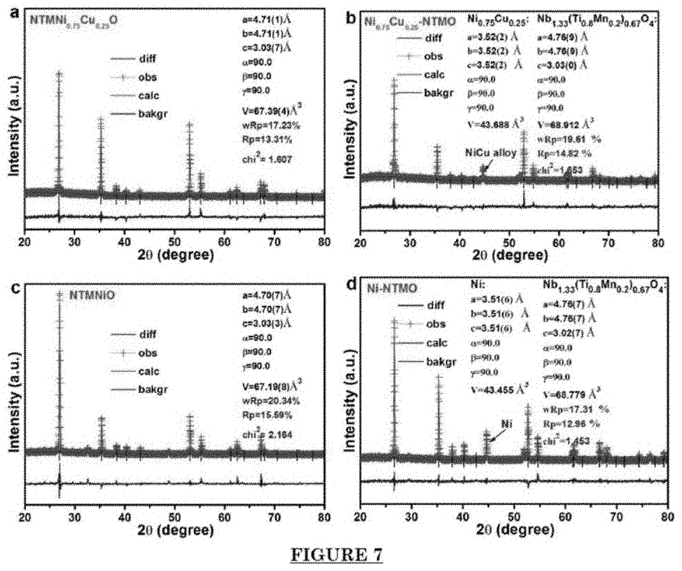

FIG. 2 at (a) shows the XRD of the synthesized NiₓCu₁₋ₓ-NTMO powder samples which indicates the homogeneous solid solutions with Ni/Cu dopant in lattice. We grow the exsolved NiₓCu1−x-NTMO interface by reducing the samples in 5% H₂/Ar. FIG. at 2 at (b) confirms the existence of NiₓCu₁₋ₓ phase after reduction. XRD rietveld refinement patterns of the samples are presented in FIGS. 6 and 7, which show at FIG. 6 XRD rietveld refinement patterns of: (a) oxidized NTMCuO; (b) reduced Cu-NTMO; (c) oxidized NTMNi_{0.25}Cu_{0.75} O; (d) reduced Ni_{0.25}Cu_{0.75}-NTMO;

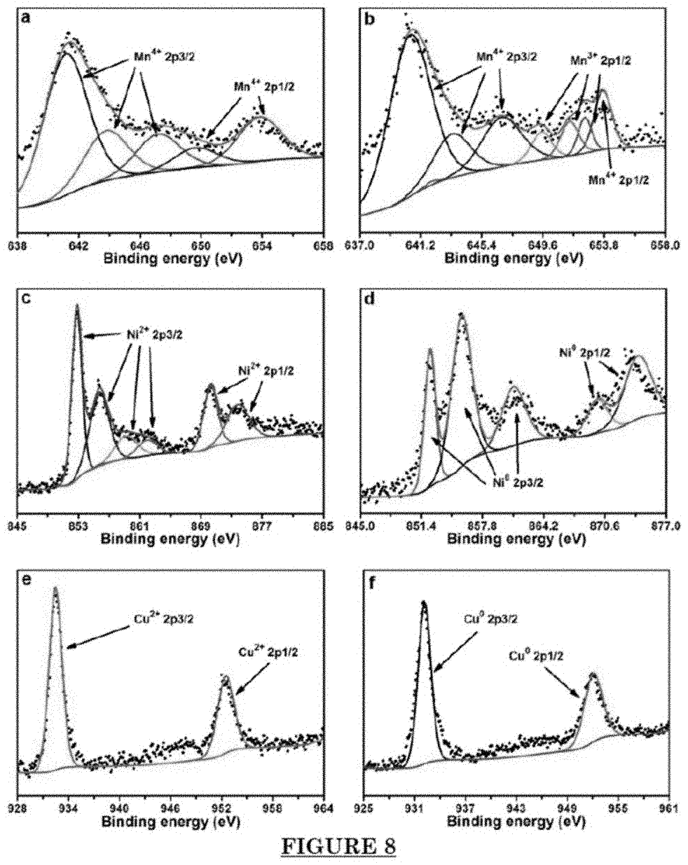

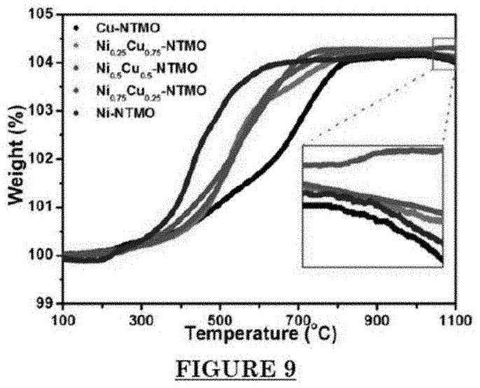

(e) oxidized NTMNi_{0.5}Cu_{0.5}O; (f) reduced Ni_{0.5}Cu_{0.5}-NTMO and FIG. 7 shows XRD rietveld refinement patterns of (a) oxidized NTMNi_{0.75}Cu_{0.25}O; (b) reduced Ni_{0.75}Cu_{0.25}-NTMO; (c) oxidized NTMNiO; (d) reduced Ni-NTMO. XPS in FIG. 8, which shows X-ray photoelectron spectroscopy of (a) Mn, (c) Ni, (e) Cu in the oxidized NTMNi_{0.5}Cu_{0.5}O; (b) Mn, (d) Ni, (f) Cu in the reduced Ni_{0.5}Cu_{0.5}-NTMO, X-ray photoelectron spectroscopy of (a) Mn, (c) Ni, (e) Cu in the oxidized NTMNi_{0.5}Cuo 50; (b) Mn, (d) Ni, (f) Cu in the reduced Ni_{0.5}Cu_{0.5}-NTMO validates that Ni/Cu elements at metallic state after reduction, confirming the exsolution of the NiₓCu₁₋ₓ alloy from the lattice. Thermogravimetric analysis (TGA) tests in FIG. 9, which shows TGA tests of the reduced samples from 100 to 1100° C. in air, further confirm that the up to ˜100% Ni/Cu metal are exsolved in this phase decomposition process while partial Mn⁴⁺ are reduced to Mn³⁺ to create the associated oxygen vacancies in lattice. FIG. 2 at (c) gives the microstructure of Ni_{0.5}Cu_{0.5}-NTMO after reduction, showing the metal particles uniformly embedding on the oxide surface. The metal particles distribute in a very narrow range with a mean size of ˜33 nm. FIG. 2 at (d) presents the in situ grown Ni_{0.5}Cu_{0.5}-NTMO interface with metal particles deeply anchoring on NTMO backbone, which indicates a strong interaction at the exsolved interfaces. The anchoring interface architecture would not only prohibit the sintering of metal particles but also deliver enhanced resistance to carbon deposition from C₂H₆ conversion. Through a synergistic control of doping and nonstoichiometry, the exsolution of metal-oxide interface would be a universal method, which is expected to be extended to more metaloxide interfaces on scaffolds.

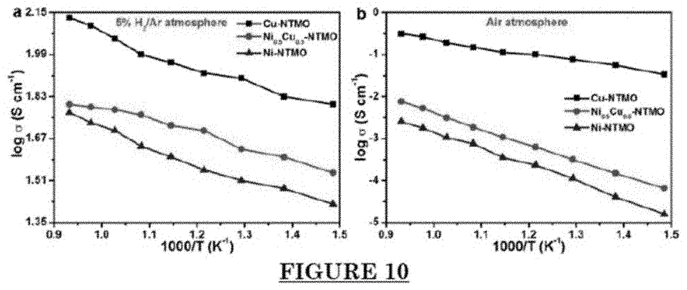

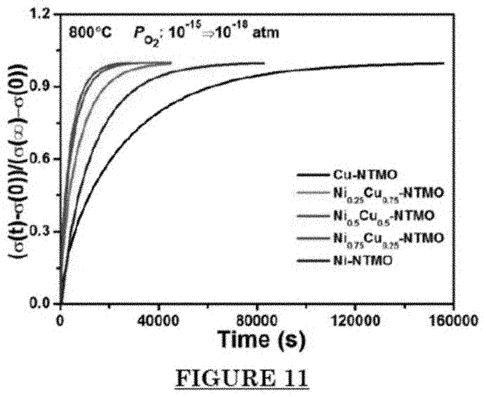

The rutile NiₓCu₁₋ₓ-NTMO oxides demonstrate a conductivity of ˜30-150 S cm⁻¹ (5% H2/Ar atmosphere) and 1.5×10−5˜0.5 S cm⁻¹ (air atmosphere) at ˜400-800° C. in FIG. 10, which shows the dependence of mixed conductivity on temperature of the reduced samples in (a) 5% H2/Ar and (b) air atmosphere. FIG. 11, which shows oxygen exchange coefficient diagrams of the reduced samples, shows the observed oxygen exchange coefficient diagram of the samples. For the rutile scaffolds, the equilibrium time shows that the growth of exsolved metal-oxide interfaces effectively enhances the oxygen exchange process. With the intimate interaction between Ni and Cu in NiₓCu₁₋ₓ alloy nanoparticles, the equilibrium time is further reduced by ˜10-100 times, indicating the significant enhancement of oxygen exchange with the metal-oxide interfaces.

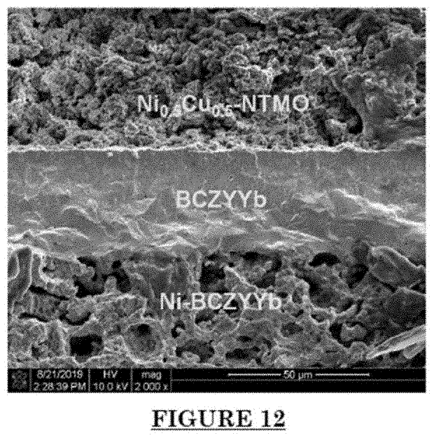

These exsolved NiₓCu₁₋ₓ-NTMO interfaces would facilitate the electrochemical dehydrogenation of C₂H₆ to C₂H₄ at external bias. A fully assembled cell consists of a dense 35 μm thick BCZYYb electrolyte on a porous Ni_{0.5}Cu_{0.5}-NTMO anode, and a porous Ni-BCZYYb cathode in FIG. 12 shows cross sectional microstructure of a solid oxide electrolyzer with a configuration of Ni_{0.5}Cu_{0.5}-NTMO-SDC|BCZYYb|Ni-BCZYYb, BCZYYb is an outstanding proton-conducting electrolyte with high ionic conductivity and proton transfer numbers at medium to high temperatures, and we thus operate the electrochemical dehydrogenation of C₂H₆ at 700° C. We conducted the nonoxidative dehydrogenation of C₂H₆ at the anode while the simultaneous transportation of proton to the cathode and forming H₂ gas. Here, we use external bias to promote C₂H₆ dehydrogenation process to generate C₂H₄ at the anode. We pre-reduce the anode to exsolve the interface architectures consisting of metal nanop articles that are grown in situ and embedded in the NTMO backbones.

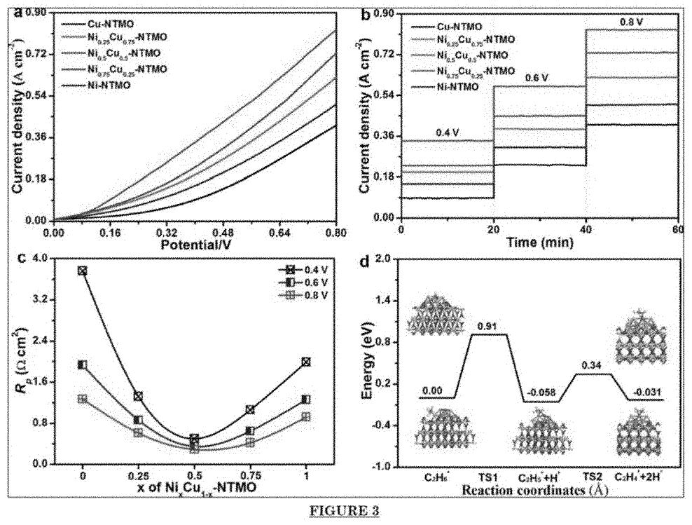

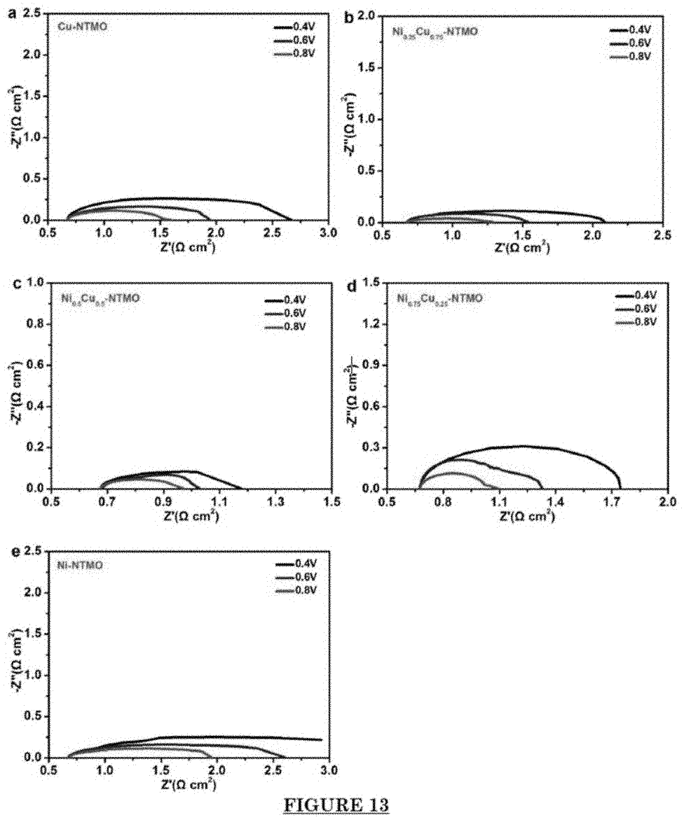

FIG. 3 at (a) presents the dependence of current density on the applied voltages, confirming that the Ni_{0.5}Cu_{0.5}-NTMO anode enhances current density by approximately 100% in contrast to the Cu-NTMO anode. The growth of alloy nanoparticles greatly increases the current density to ˜0.83 A cm⁻² at 0.8 V with the optimal interface compositions in porous NTMO backbones. FIG. 3 at (b) presents the dependence of current density on the exsolved interfaces, implying greatly improved C₂H₆ dehydrogenation with active interfaces. FIG. 13, which shows C impedance of solid oxide electrolyzers based on: (a) Cu-NTMO, (b) Ni_{0.25}Cu_{0.75}-NTMO, (c) Ni_{0.5}Cu_{0.5}-NTMO, (d) Ni_{0.75}Cu_{0.25}-NTMO, (e) Ni-NTMO anodes under various potentials at 700° C., demonstrates the lowest electrode polarization resistance of ˜0.3 Ωcm² at 0.8 V with the Ni_{0.5}Cu_{0.5}-NTMO anode, indicating the significantly enhanced the electrode activity toward C₂H₆ conversion. The compositions of NiₓCu₁₋ₓ-NTMO interface can further continuously engineer the catalysis activity of anodes with exsolved interface architectures. Additionally, the optimum composition of Ni_{0.5}Cu_{0.5}-NTMO is observed to deliver the highest electrode activity.

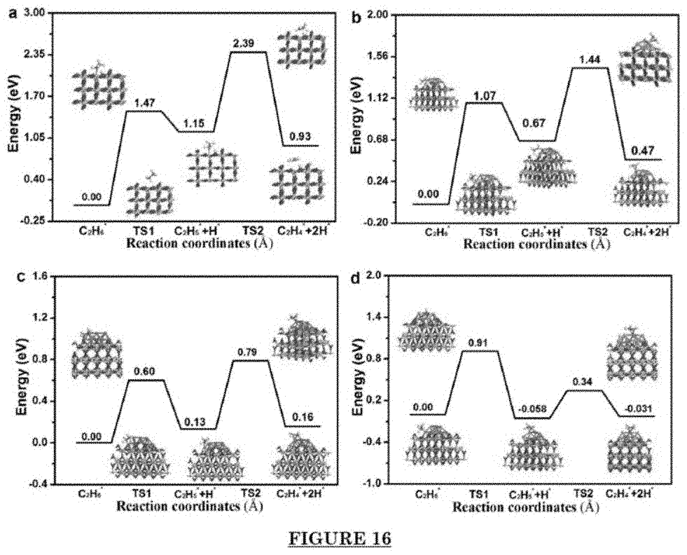

FIG. 3 at (c) shows the summarized data of the electrode polarization resistances of the nonoxidative dehydrogenation of C₂H₆ with different interface compositions at 0.4-0.8 V at 700° C. The results show that the decrease of electrode polarization resistance is closely related to the synergistic control of interface compositions and applied voltages. We further conduct theoretical calculation of transition states to understand the dehydrogenation of C₂H₆ to C₂H₄ at the metal-oxide interface. FIG. 14 shows optimization structure and binding energy of clusters: (a) Ni11 cluster; (b) Cu11 cluster; (c) (Ni—Cu)-1 cluster; (d) (Ni—Cu)-2 cluster; (e) (Ni—Cu)-3 cluster; (f) (Ni—Cu)-4 cluster, which shows the interface models with different configurations in which we simulate the metal-oxide interface with different metal clusters stacked on defected TiO₂ surface. FIG. 15 shows different adsorption configurations of ethane on the TiO₂ system: (a) the defect surface; (b) the Ni/TiO₂ system; (c) the Cu/TiO₂ system; (d) the Ni—Cu/TiO₂ system, and shows the adsorption configurations of C₂H₆ at the surface of defected TiO₂ and the metaloxide interface, which clearly confirms the enhanced chemical adsorption with interface interactions in contrast to defected surfaces. FIG. 3 at (d) presents that the energy barrier is 0.91 and 0.40 eV for the dehydrogenation of C₂H₆ at NiCu/TiO₂ interface, which is much lower than those at the Ni/TiO₂ and Cu/TiO₂ interface, indicating that the coupling between defected surface and metal alloy clusters is beneficial to the dehydrogenation progress. We present the calculated transition states of the dehydrogenation progress at Ni/TiO₂ and Cu/TiO₂ in FIG. 16, which shows a potential energy profile for the ethane dehydrogenation on (a) TiO₂ defect surface, (b) Cu/TiO₂ interface, (c) Ni/TiO₂ interface and (d) NiCu/TiO₂ interface. The metaloxide interfaces architecture is expected to highly facilitate the dehydrogenation process while the alloying effects would further enhance the catalysis activity, which well fits our observed experimental results.

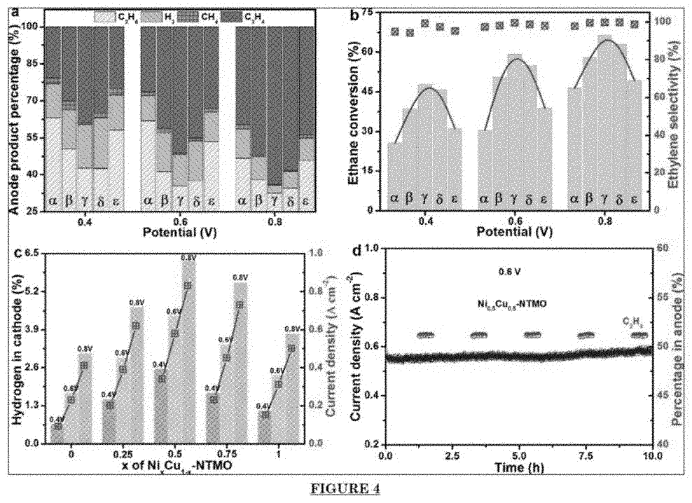

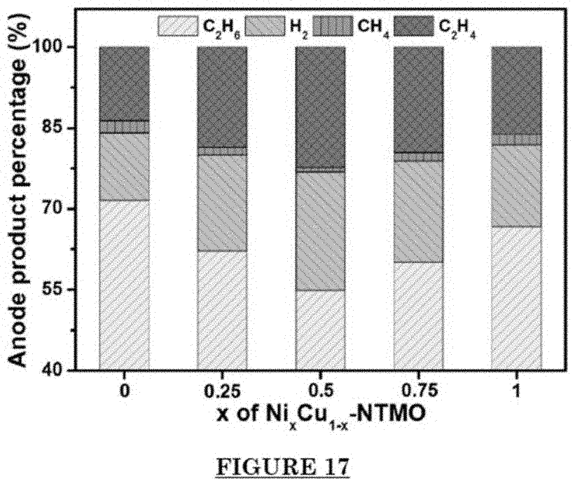

FIG. 4 at (a) presents the anode product analysis during the electrochemical nonoxidative dehydrogenation of C₂H₆ with different NiₓC₁₋ₓ compositions while the protons are ionically pumped to the cathodes. Here 100% concentration of C₂H₆ is supplied to the anode for electrochemical measurements. We study the thermal cracking of C₂H₆ under open circuit conditions and we confirm 30.5% of C₂H₆ conversion in FIG. 17, which shows the product analysis from thermal splitting C₂H₆ in the anode of solid oxide electrolyzer without externally applied voltages at operation temperature of 700° C. When a voltage is applied, C₂H₄ concentrations positively depend on applied potential, which indicates that C₂H₆ can be successfully converted to C₂H₄ by this electrochemical method even though there still exists some H₂ and a small amount of CH₄ in the anode. The C₂H₆ conversion reaches 66.3% with C₂H₄ selectivity of 99.7% in FIG. 4 at (b) at 0.8 V, which is the best C₂H₆ conversion and C₂H₄ selectivity in contrast to the reported C₂H₆ conversion both in oxidative and nonoxidative processes. It is observed that the exsolved interfaces increase the C₂H₄ production by about 35-50%, which indicates the favorable cleavage of C—H bonds at interfaces. The dehydrogenation process is thus controlled by the synergy of external voltage and interface compositions at the anode. FIG. 4 at (c) shows the electrochemical pumping of protons from the anode to the cathode and form H₂, while the amount of H₂ depends on the current. The Ni_{0.5}Cu_{0.5}-NTMO anode gives 0.83 A cm⁻² at 0.8 V, in which ˜6.3% H₂ is generated in the cathode. The electrochemical performance is significantly enhanced by using ceramic Ni_{0.5}Cu_{0.5}-NTMO electrode with exsolved metaloxide interfaces, while the C₂H₆ conversion together with C₂H₄ yields and selectivity are therefore remarkably improved in contrast to the nickel-cermet anode. See, Ding, D.; Zhang, Y.; Wu, W.; Chen, D.; Liu, M.; He, T. A Novel Low-Thermal-Budget Approach for the Co-Production of Ethylene and Hydrogen via the Electrochemical Non-Oxidative Deprotonation of Ethane. Energy Environ. Sci. 2018, 11, 1710-1716.

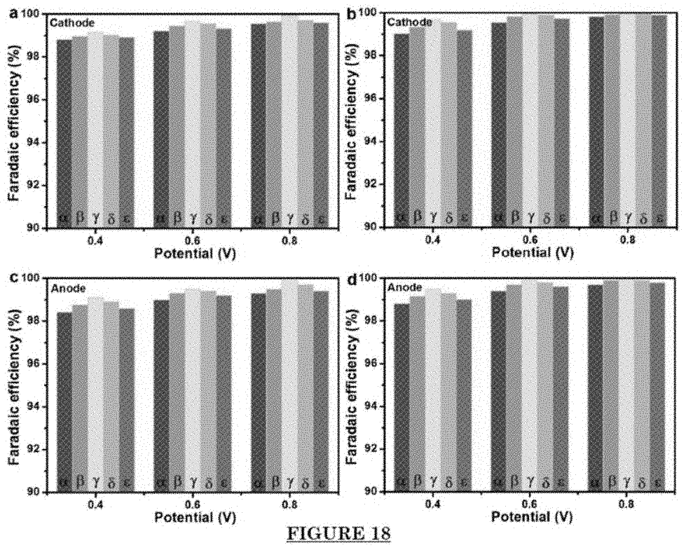

The electrochemical dehydrogenation of C₂H₆ leads to the generation of C₂H₄ in the anode, while thermal splitting of C₂H₆ to C₂H₄ is also present in the anode. We observed ˜100% of Faraday efficiency for the generation of H H₂ in cathode for electrochemical C₂H₆ dehydrogenation as shown in FIG. 18 at (a). FIG. 18 shows: (a) the Faradaic efficiency for H₂ in cathode for electrochemical dehydrogenation of C₂H₆; (b) the Faradaic efficiency for CO/H₂ in cathode for electrochemical dehydrogenation of C₂H₆ in conjunction with CO₂ reduction in cathode; (c) the Faradaic efficiency for C₂H₄ production in anode for electrochemical dehydrogenation of C₂H₆; (d) the Faradaic efficiency for C₂H₄ production in anode for electrochemical dehydrogenation of C₂H₆ with CO₂ reduction. (α: Cu-NTMO, β: Ni_{0.25}Cu_{0.75}-NTMO, Y: Ni_{0.5}Cu_{0.5}-NTMO, δ: Ni_{0.25}Cu_{0.75}-NTMO, ε: Ni-NTMO). The Faraday efficiency is ˜100% for C₂H₄ production in the process of electrochemical dehydrogenation of C₂H₆ in FIG. 18 at (c). The extra C₂H₄ in the anode is from thermal splitting of C₂H₆, which could be considered as background even though some fluctuations may be present in different processes.

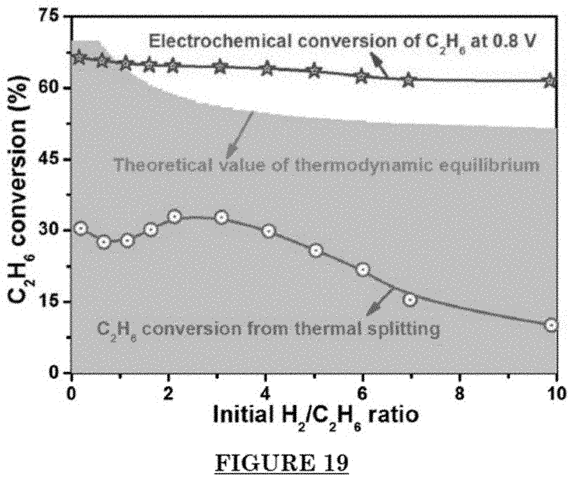

In control experiments, we supplied a mixture of H₂/C₂H₆ with the ratio in the range of 0-10 to anode for the thermal splitting tests under open circuit conditions. We observed that the C2H6 conversion only reaches 30.5% with the H₂/C₂H₆ ratio at 0, which is far below the theoretical conversion of 70.0%. It is observed that higher H₂ content leads to lower C₂H₆ conversion for the H₂/C₂H₆ ratio ranging from 0 to 10. At the H₂/C₂H₆ ratio of 10, the C₂H₆ conversion is significantly decreased to 10.2%, which is remarkably lower than the theoretical C₂H₆ conversion of 51.5%. The presence of H₂ with concentration in a wide range in anode significantly changes the C₂H₆ conversion in the thermal splitting process. In contrast, we supplied a mixture of H₂/C₂H₆ with the ratio in the range of 0-10 to anode for the electrochemical dehydrogenation tests. As shown in FIG. 19, which shows the C₂H₆ conversion at different modes with Ni_{0.5}Cuo_{0.5}-NTMO anode in solid oxide electrolyzer, the C₂H₆ conversion is as high as 66.3% at the H₂/C₂H₆ ratio of 0, which is comparable to the theoretical C₂H₆ conversion of 70.0% and significantly higher than the observed C₂H₆ conversion of 30.5% in thermal splitting tests under open circuit conditions.

The enhancement of C₂H₆ conversion confirms the dominance of electrochemical C₂H₆ conversion. At the H₂/C₂H₆ ratio of 10, the C₂H₆ conversion still maintains a value of as high as 61.6%, which further confirms the dominance of electrochemical C₂H₆ conversion even in a gas mixture with initial C₂H₆ content lower than 10%. The electrochemical pumping of proton from C₂H₆ gives rise to the enhanced C₂H₆ conversion even with a significantly high content of hydrogen. It should be noted that the conversion of 100% C₂H₆ can reach 75.2% in the anode in the electrochemical dehydrogenation process if combined with CO₂ reduction in the cathode as discussed later, which is much higher than the 70.0% conversion as calculated from the thermodynamic equilibrium in thermal splitting.

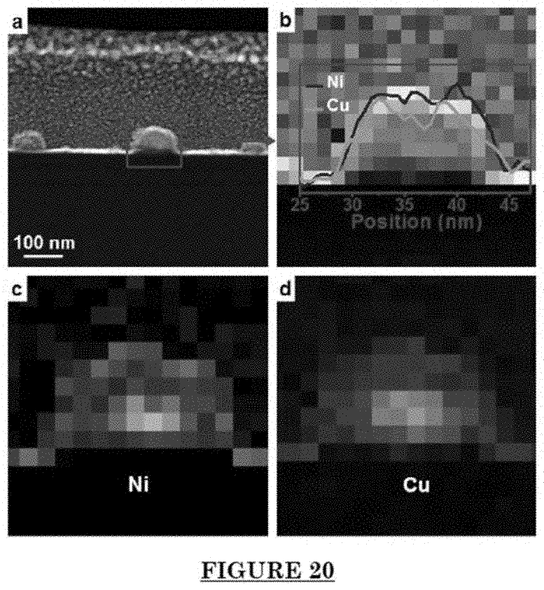

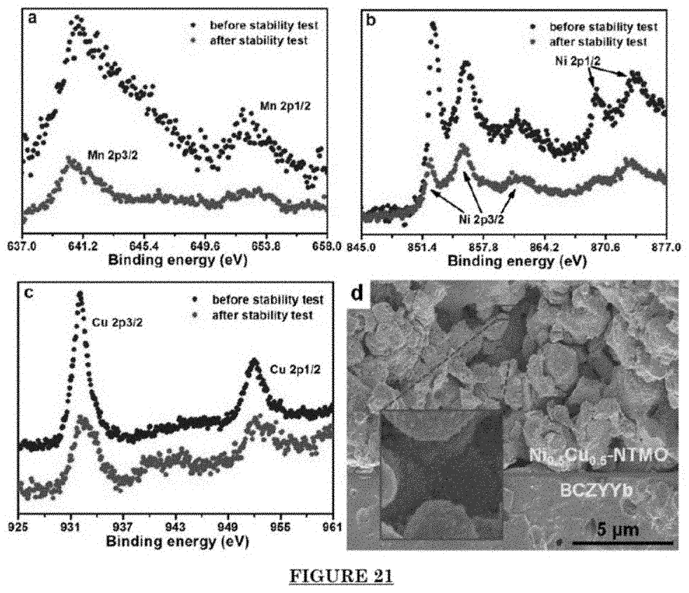

FIG. 4 at (d) presents the operation of the nonoxidative dehydrogenation of C₂H₆ with the Ni_{0.5}Cu_{0.5}-NTMO anode in a proton-conducting SOE, which indicates remarkable stability after 10 h at 700° C. and 0.6 V. The current density and C₂H₄ generation remain stable during the operation. Exsolved interface architectures lead to enhanced stability by preventing nanop articles from coalescing due to a decrease in surface energy. This strong interfacial interaction would also give rise to improved charge transfer and coking resistance at high temperatures. We isolate a single nanoparticle anchored on the NTMO scaffold after tests. As shown in FIG. 20, which shows at: (a) the EDX mapping in HAADF-STEM mode of Ni_{0.5}Cu_{0.5}-NTMO anode after stability test for electrochemical dehydrogenation of C₂H₆; (b) EDX elemental line analysis across typical Ni_{0.5}Cu_{0.5} particle; (c, d) Cu and Ni mapping of the exsolved nanoparticle, the nanoparticle is deeply anchored on the NTMO substrate while Cu and Ni are homogeneously distributed in the particle, revealing the homogeneous alloying features of the metal nanoparticles. The microstructure of the Ni_{0.5}Cu_{0.5}-NTMO anode generally remains unchanged after the stability test. In addition, no coking formation is visually observed in Ni_{0.5}Cu_{0.5}-NTMO anode after stability test for electrochemical dehydrogenation of C₂H₆. As shown in FIG. 21, which shows X-ray photoelectron spectroscopy of: (a) Mn, (b) Ni, (c) Cu in Ni_{0.5}Cu_{0.5}-NTMO anode before and after stability test for electrochemical dehydrogenation of C₂H₆; (d) SEM images of the Ni_{0.5}Cu_{0.5}-NTMO porous electrodes after stability test for C₂H₆ conversion, the chemical state of the Mn, Ni, and Cu remain basically unchanged before and after stability test. The microstructure of the porous Ni_{0.5}Cu_{0.5}-NTMO anode maintains well after the stability test. The embedding effect would provide improved high temperature stability against the severe long-term agglomeration and carbon deposition from C₂H₆ conversion.

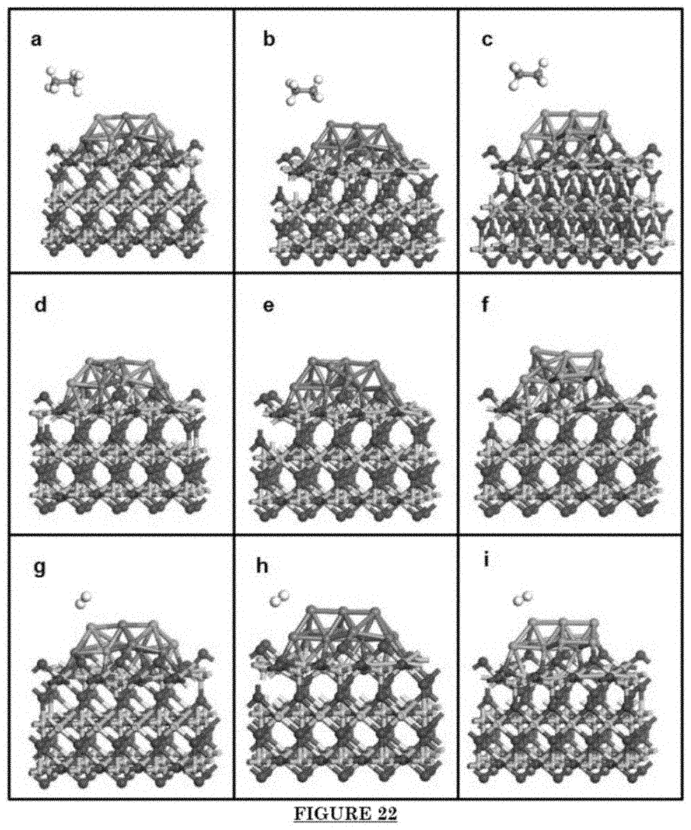

In our work, the deep cracking of ethane would lead to carbon formation on electrodes. We exsolved metal-oxide interface architectures and add copper to nickel to form alloying effects to enhance coking resistance. One reason would be the strong interactions at the exsolved interfaces that enhances coking resistance. The other would be the alloying effects with strong interactions between different elements that can further enhance the resistance to carbon deposition. It is well-known that the C formed during the dehydrogenation of ethane results from the deep cracking of ethane. We simplify the oxide as defected TiO₂ and then construct a model of metal-oxide interfaces. FIG. 22, which shows an optimized structure of ethane deep cracking process: (a-c) C₂H₆ (g) on cluster/TiO₂ system; (d-f) C adsorbed on cluster/TiO₂ system; (g-i) H₂ (g) on cluster/TiO₂ system. (a), (d) and (g): on (Ni—Cu)/TiO₂ system; (b), (e) and (h): on Ni/TiO₂ system; (c), (f) and (i): on Cu/TiO₂ system, presents the Gibbs free energy of the ethane deep cracking process calculated from the reaction equation as follows:

C₂H₆ (g)+2*=2C*+3H₂(g)

where “C*” is C atom adsorbed on cluster/TiO₂ system, and “*” provides active position. C₂H₆ (g) and H2 (g) means that ethane and hydrogen are in gaseous state. The Gibbs free energy is calculated by

ΔG=ΔE+ΔZPE−TΔS

where ΔE is the energy calculated by DFT; ΔZPE is the zero-point energy; T is the temperature; ΔS is the Entropy. The Gibbs free energy of the progress is 0.306 eV on Ni/TiO₂ system, which is much lower than the 3.24 eV on Cu/TiO₂ system. It should be noted that the Gibbs free energy of the progress is enhanced to 2.45 eV on (Ni—Cu)/TiO₂ system. It suggests that it might not be a difficult process for the ethane deep cracking on the Ni/TiO₂ system but that the alloy effectively increases the energy barrier and therefore significantly enhances the coking resistance for the ethane dehydrogenation process.

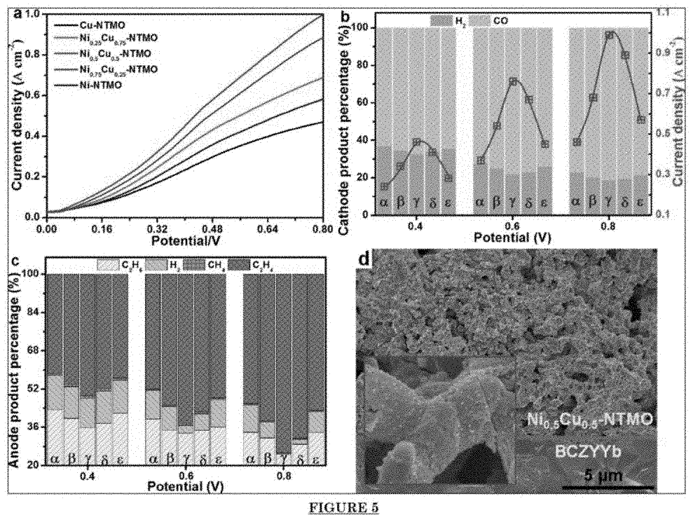

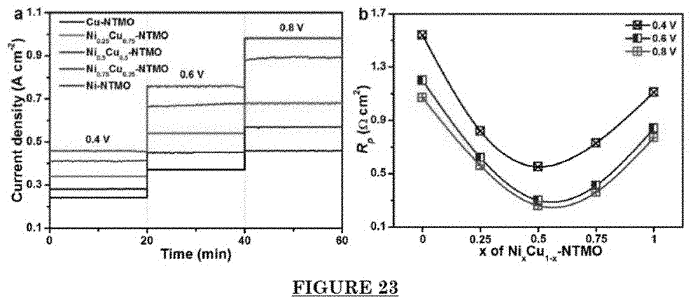

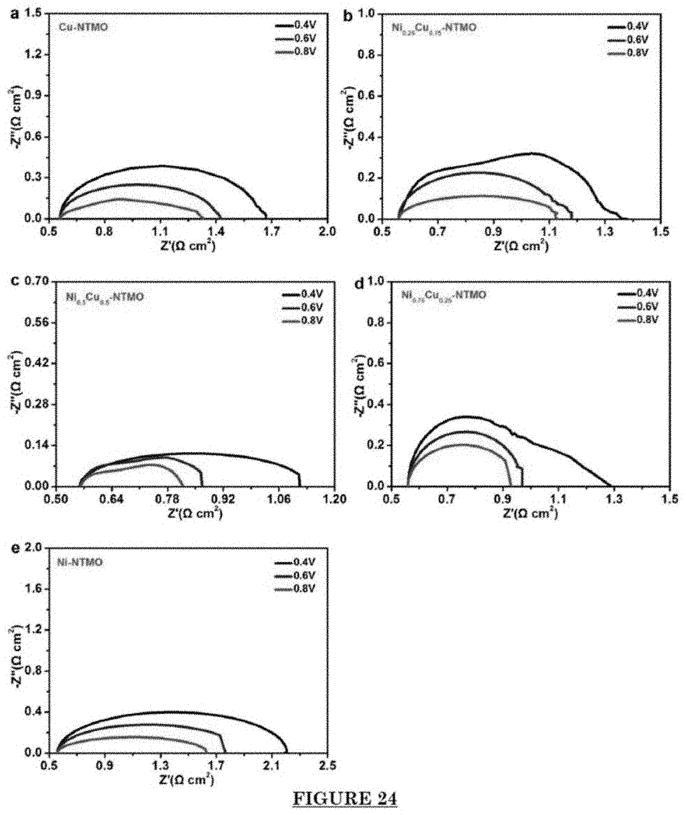

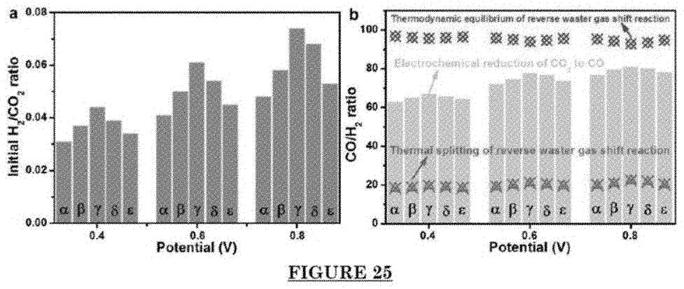

This electrochemical process includes the C₂H₆ conversion in the anode and the ionically pumping protons from anode to cathode. FIG. 5 at (a) shows the electrochemical performance of CO₂ reduction in the cathode in combination with C₂H₆ dehydrogenation in the anode at the same time. The exsolved interface architectures in porous anode backbones enhance the performances with the optimum interface composition of Ni_{0.5}Cu_{0.5}-NTMO observed. A similar changing trend is also observed for short-term performance and in situ impedance in FIGS. 23 and 24. FIG. 23 shows at: (a) the short-term operation of C₂H₆ dehydrogenation with the composite anodes in combination with CO₂ reduction at different voltages; (b) the electrode polarizations with different anodes at 0.4-0.8 V at 700° C. FIG. 24 shows AC impedance of solid oxide electrolyzers based on: (a) Cu-NTMO, (b) Ni_{0.25}Cu_{0.75}-NTMO, (c) Ni_{0.5}Cu_{0.5}-NTMO, (d) Ni_{0.75}Cu_{0.25}-NTMO, (e) Ni-NTMO anodes under various potentials at 700° C. FIG. 5 at (b) shows the H2/C0 ratio versus interface compositions and external voltages, which displays that the higher external bias promote CO₂ reacting with H⁺ while the best composition is the Ni_{0.5}Cu_{0.5}-NTMO composite with an appropriate interface composition in the anode. We conduct a control experiment by directly pumping the gas mixture of H₂/CO₂ to cathode under open circuit conditions, where the supplied 112 is identical to the H₂ generation amount in the cathode during electrochemical C₂H₆ dehydrogenation as shown in FIG. 25 at (a). FIG. 25 shows: (a) directly pumping the gas mixture of H₂/CO₂ to cathode under open circuit conditions, where the H₂ is identical to the H₂ generation amount in cathode during electrochemical C₂H₆ dehydrogenation; (b) the ratio of CO/H₂ at different modes in the cathode. The ratio of CO/H2 is generally at ˜99:1 calculated from the thermodynamic equilibrium of reverse waster gas shift reaction as shown in FIG. 25 at (b). In addition, the observed ratio of CO/H₂ in control experiment is only ˜20:1, which indicates that the CO generation is far below the thermodynamic equilibrium of reverse gas shift reaction under open circuit conditions. In the electrochemical process, the observed ratio of CO/H₂ is enhanced to as high as ˜80:1, which implies that the electrochemical reduction of CO₂ to CO may be a dominant reaction even though the reverse water shift gas reaction is still present.

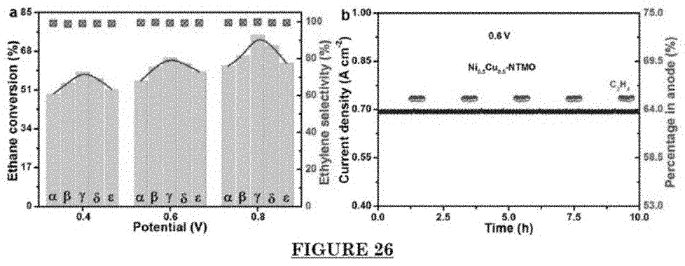

FIG. 5 at (c) shows the conversion of C₂H₆ to chemicals at the anode and CO₂ reduction is simultaneously performed at the cathode. The C₂H₄ selectivity of 99.9% and the C₂H₆ conversion of 75.2% are reached in the Ni_{0.5}Cu_{0.5}-NTMO anode at ambient pressure and 0.8 V as shown in FIG. 5 at (c) and FIG. 26 at (a). FIG. 26 shows: (a) C₂H₆ conversion and C₂H₄ selectivity in anode in combination with CO₂ reduction in cathode; (b) the short term performance of the electrochemical dehydrogenation of C₂H₆ with the Ni_{0.5}Cu_{0.5}-NTMO anode in a proton-conducting solid oxide electrolyzer. (α: Cu-NTMO, β: Ni_{0.25}Cu_{0.75}-NTMO, Y: Ni_{0.5}Cu_{0.5}-NTMO, δ: Ni_{0.75}Cu_{0.25}-NTMO, ε: Ni-NTMO). This higher performance of integrating CO₂ reduction in the cathode with electrochemical dehydrogenation of C₂H₆ in the cathode would be attributed to the reduced electrochemical potential between the two electrodes that greatly improves the dehydrogenation process of C₂H₆ in the anode. We also observe ˜100% of Faraday efficiency for CO/H₂ in the cathode for electrochemical dehydrogenation of C₂H₆ in conjunction with CO₂ reduction in the cathode as shown in FIG. 18 at (b). The Faraday efficiency is ˜100% for C₂H₄ production in the process of electrochemical dehydrogenation of C₂H₆ with CO₂ reduction in FIG. 18 at (d). The conversion of 100% C₂H₆ can reach ˜75.2% in the anode in the electrochemical dehydrogenation process combined with CO₂ reduction in the cathode by decreasing the overpotentials between the two electrodes, which is much higher than the ˜70.0% conversion calculated from the thermodynamic equilibrium in thermal splitting under operation conditions. FIG. 26 at (b) presents the operation of the nonoxidative dehydrogenation of C₂H₆ for 10 h, which further validates the stability even with CO₂ reduction in the cathode. In FIG. 5 at (d), we find clear structures of the porous Ni_{0.5}Cu_{0.5}-NTMO electrode which adhere well to the BCZYYb electrolyte, indicating a compatibility between electrode and electrolyte after the electrochemical test. The Ni_{0.5}Cu_{0.5} particles remain basically unchanged without obvious carbon deposition, which indicates resistance to agglomeration, sintering, and carbon deposition of the interface architectures.

In summary, the current disclosure shows an alternative approach to electrochemically convert C₂H₆ to C₂H₄ with high C₂H₆ conversion, high C₂H₄ selectivity in a proton-conducting solid oxide electrolyzer. We in situ exsolve metaloxide interface architectures at nanoscale to deliver strong interface interactions, which enhances the C—H bonds activation, sintering stability, and coking resistance. Electrochemical nonoxidative dehydrogenation of C₂H₆ in the anode in combination with CO₂ reduction in the cathode shows the enhanced C₂H₆ conversion of 75.2% with ˜100% C₂H₄ selectivity. The electrochemical pumping of hydrogen ions at metal-oxide interfaces facilitates the exceptionally high anode activity, while the interface compositions further engineer the ethane conversion. The porous anode backbone with in situ grown metal-oxide interfaces at nanoscale displays significantly improved catalyst stability and coking resistance. This work not only provides an efficient and reliable electrochemical process for C₂H₆ conversion but also offer an abundant alternative for other alkane conversions into worthy chemicals.

Various modifications and variations of the described methods, pharmaceutical compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. A method for forming an improved fuel cell comprising:
electrochemical pumping of protons at at least one anode;
enhancing anode activity with at least one exsolved metal-oxide interface;
converting ethane to ethylene at the at least one anode;
reducing carbon dioxide to carbon monoxide at the at least one cathode; and
producing syngas at the at least one cathode.

2. The method of claim 1, wherein electrochemical pumping of protons employs at least one barium zirconate cerate electrolyte.

3. The method of claim 1, further comprising restraining carbon coking with respect to converting ethane to ethylene.

4. The method of claim 1, further comprising applying an external voltage to tailor converting ethane to ethylene.

5. The method of claim 1, further comprising employing a redox-reversible ceramic electrode.

6. The method of claim 5, wherein the redox-reversible ceramic electrode comprises NbTiO.

7. The method of claim 1, further comprising doping Mn in a lattice to create oxygen vacancy to facilitate ionic conduction.

8. The method of claim 1, further comprising forming a scaffold to accommodate the exsolved metal-oxide interface for electrochemical dehydrogenations of ethane in a solid oxide electrolyzer.

9. The method of claim 1, further comprising forming at least one electrode slurry comprising Ni-NTMO and barium zirconate cerate.

10. The method of claim 1, wherein the syngas comprises hydrogen gas.

11. An electrochemical fuel cell system comprising:
at least one proton conducting solid oxide electrolyzer for providing a nonoxidative dehydrogenation process;
at least one anode comprising at least one alloy nanoparticle exsolved onto at least one backbone to form an embedded metal-oxide interface structure, wherein the embedded metal-oxide interface structure facilitates dehydrogenation of ethane to ethylene;
at least one cathode configured for reducing CO₂; and
at least one electrode slurry.

12. The system of claim 11, wherein the at least one alloy nanoparticle comprises NiCu and the at least one backbone comprises NTMO.

13. The system of claim 11, wherein the at least one cathode comprises Ni-BCZYYb.

14. The system of claim 11, wherein the at least one electrode slurry comprises Ni-NTMO and barium zirconate cerate.

15. The system of claim 11, wherein the embedded metal-oxide interface structure forms an anchoring interface architecture that prohibits sintering of metal particles and resists carbon deposition.

16. The system of claim 11, wherein the anode is configured to conduct nonoxidative dehydrogenation of ethane to ethylene.

17. The system of claim 11, wherein the cathode is configured to produce hydrogen gas.

18. The system of claim 11, wherein the embedded metal-oxide interface structure is exsolved in situ and at formed at a nanoscale.
